(19) United States
(12) Patent Application Publication
(10) Pub. No.: US 2004/0105414 A1
(43) Pub. Date: Jun. 3, 2004

(54) Multi-hop wireless network data forwarding

(76) Inventors: Sathya R. Narayanan, Plainsboro, NJ (US); Daisaku Komiya, Yokohama-shi (JP); Rajesh B. Khandelwal, Bridgewater, NJ (US); Symeon Papavassiliou, Fort Lee, NJ (US); Sheng Xu, Harrison, NJ (US)

Correspondence Address: RATNERPRESTIA, P O BOX 980, VALLEY FORGE, PA, 19482-0980, US

(21) Appl. No.: 10/663,534

(22) Filed: Sep. 16, 2003

Related U.S. Application Data
(60) Provisional application No. 60/319,745, filed on Dec. 2, 2002.

(51) Int. Cl. H04Q 7/24

(52) U.S. Cl. 370/338

(57) ABSTRACT

A data communication system and method for forwarding data messages in a wireless network having an access point is disclosed. To forward data messages in accordance with the present invention, levels with respect to the access point are determined for wireless devices within the wireless network. Data messages are then transferred sequentially by level between the access point and other wireless devices within the wireless network.

### CROSS REFERENCE TO RELATED APPLICATIONS

This application is related to and claims the benefit of U.S. Provisional Application No. 60/319,745 entitled MULTI-HOP BRIDGE FOR TRANSFERRING DATA IN A WIRELESS NETWORK filed on Dec. 2, 2002.

### FIELD OF THE INVENTION

The present invention relates to wireless networks and, more particularly, to forwarding data in a wireless network.

### BACKGROUND OF THE INVENTION

Wireless networks are a collection of wireless devices capable of communicating with one another using a wireless medium such as infra red (IR), radio frequency (RF), or other such wireless communication medium. Recent advances in wireless technology have led to an increased use of these wireless networks. Methods for forwarding data in a wired network do not translate well to wireless networks because the topology of a wired network remains the same while it may continually change in a wireless network.

Present wireless networks typically operate in either an infrastructure mode or an ad hoc mode. In the infrastructure mode, the wireless network consists of an access point connected to a wired network and to one or more wireless devices. The access point acts as the base station for the wireless network through with the one or more wireless device access the wired network. In the ad hoc mode, the wireless devices communicate directly with one another without the use of an access point.

Conventional wireless network specifications permit only direct communication, i.e., “one hop,” between an access point and a wireless device or between two wireless devices. Thus, in the infrastructure mode, each wireless device must be within transmission range of the access point to gain access to the wired network. Proposals to extend the range of a wireless network to enable access with a wired network allow “multi-hop” connections between the access point and a wireless device through one or more other wireless devices. In these proposals, data is routed in the network layer of a conventional Internet protocol stack in each of the wireless devices. Forwarding data in the network layer requires a significant amount of processing overhead by the wireless devices, however, which adversely affects the efficiency of these wireless devices.

Accordingly, systems and methods are needed that address the above limitations. The present invention fulfils this need among others.

### SUMMARY OF THE INVENTION

The present invention is a system and method for forwarding data in a wireless network between an access point and other wireless devices within the wireless network. To forward data messages in accordance with the present invention, levels are determined for wireless devices within the wireless network with respect to the access point. Data messages are then forwarded sequentially by level between the access point and the other wireless devices within the wireless network.

### BRIEF DESCRIPTION OF THE DRAWINGS

FIG. 1 is an illustration of a plurality of wireless devices within a wireless network in accordance with the present invention;

FIG. 2A is a block diagram illustrating exemplary hardware of a single wireless device for use in a wireless network in accordance with the present invention;

FIG. 2B is a block diagram illustrating exemplary packet and data flow within a single wireless device for use in a wireless network in accordance with the present invention;

FIG. 3 is a table depicting known Internet protocol layers;

FIG. 4 is an illustration of the wireless network of FIG. 1 with the wireless devices grouped into levels in accordance with the present invention;

FIG. 5 is a flow chart depicting exemplary steps for determining levels of wireless devices within a wireless network in accordance with the present invention;

FIG. 6 is a flow chart depicting exemplary steps for forwarding data messages upstream to an access point in accordance with the present invention; and

FIG. 7 is a flow chart depicting exemplary steps for forwarding data messages downstream from an access point in accordance with the present invention.

### DETAILED DESCRIPTION OF THE INVENTION

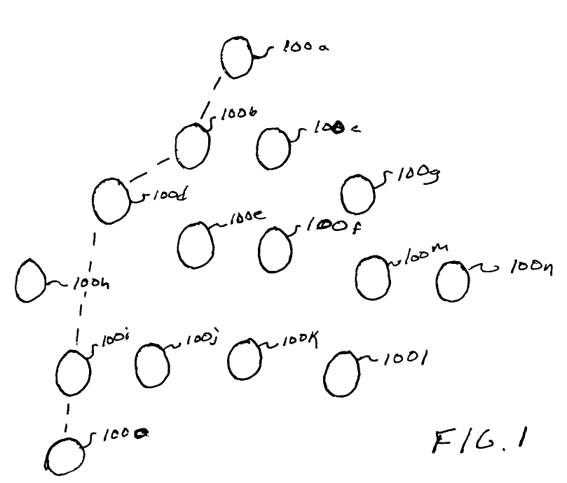

FIG. 1 depicts a plurality of wireless devices 100 (with specific devices referred to using lower case letters) capable of communicating with one another either directly or indirectly. Together, the wireless devices 100 form a wireless network. In an exemplary embodiment, one of the wireless devices is an access point, e.g., wireless device 100a, through which all communications within the wireless network pass. In certain exemplary embodiments, the access point is coupled to an external communication system (not shown) such as a conventional wired network. In this exemplary embodiment, the other wireless devices, e.g., wireless devices 100b-100o, may access the external communication system via the access point. Although fifteen (15) wireless devices 100 are illustrated, the present invention may be implemented in any wireless network employing two or more wireless devices 100 where one of the wireless devices is designated as an access point.

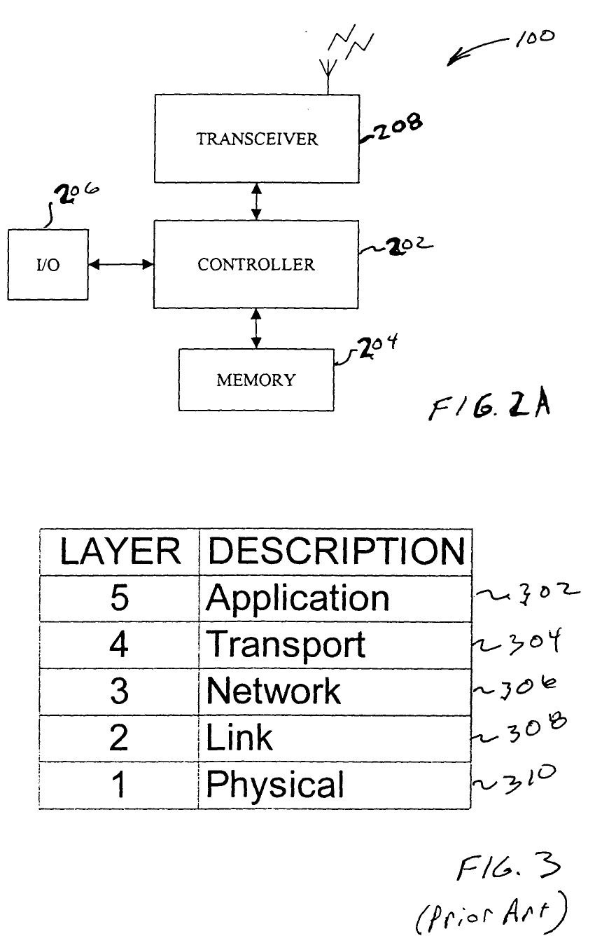

FIG. 2A depicts exemplary hardware within a wireless device 100. The illustrated device 100 includes a controller 202, a memory 204, an input/output (I/O) device 206, and a transceiver 208. The controller 202 communicates with the memory 204, I/O device 206, and transceiver 208 to process data and establishes wireless communication with other wireless devices to form a wireless network. The transceiver 208 is a wireless transceiver capable of sending/receiving data using one or more wireless communication mediums, e.g., radio frequency (RF), infra red (IR), or other such communication medium. In an exemplary embodiment, the wireless device 100 is capable of communicating with other wireless devices according to IEEE 802.11 specifications (referred to herein as the “802.11 standard”) created by the Institute of Electrical and Electronics Engineers (IEEE) Inc. A suitable wireless device for use with the present invention will be readily apparent to those of skill in the art of wireless networking.

FIG. 2B depicts exemplary packet and data flow within a wireless device 100. The wireless device as depicted in FIG. 2B includes a Media Access Control (MAC) layer 210, a beacon control 212, a forwarding table 214, a forwarding module 216, and upper layer protocols 218. The MAC layer 210 is a standard wireless protocol layer. Packets flow between the MAC layer 210 and the beacon control 212. The beacon control 212 is responsible for exchanging beacons (broadcasts), described in further detail below, with neighboring nodes to identify neighboring nodes and their relationship to one another with respect to an access point. In addition, the beacon control 212 transmits data to the forwarding table 214, which maintains neighbor information for the node, to add or remove neighbor node entries based on the beacon exchange results. The forwarding module 216 receives all incoming packets via the Media Access Control (MAC) layer and determines the next destination for each packet responsive to data in the forwarding table 214. The forwarding module 216 passes packets for delivery to another node back to the MAC layer 210 and packets for delivery to the current node to the upper layer protocols 218 (e.g., web browser, e-mail, etc.) for processing. The upper layer protocols 218 pass packets for delivery to other nodes to the MAC layer 210.

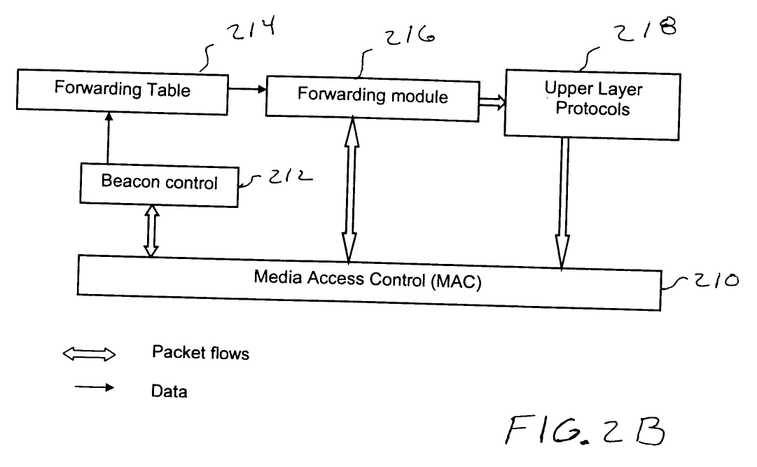

In an exemplary embodiment, each wireless device 100 operates according to a conventional Internet protocol stack such as depicted in FIG. 3. An application layer 302 supports network applications, such as applications for interacting with remote devices, transferring files, or displaying graphics obtained from another device or network. A transport layer 304 packages data for host-to-host delivery. A network layer 306 places data into packets, organizes the packets for transmission between devices, and provides a consistent way of identifying the location of devices and forwarding data. A link layer 308 controls operation of a single data communication link to move information efficiently from one device to another. An important function of this layer is Media Access Control (MAC), which allows multiple computers to share a single information channel. A physical layer 310 includes physical hardware for passing information between two physical locations. In an exemplary embodiment of the present invention, data is forwarded from wireless device to wireless device in the link layer 308, rather than routed in the network layer 306 as in conventional ad hoc wireless networks, thereby reducing processing overhead.

In an exemplary embodiment, the link layer 308 in the present invention is based on the 802.11 standard, which defines a data frame that includes a preamble, a physical layer convergence protocol (PCLP) header, media access control (MAC) data, and a cyclic redundancy code (CRC) value for the data frame. The MAC data includes a frame control data field, a duration/ID field, four address values, a sequence control field, 4626 bytes of payload data and a separate CRC code for the MAC data. The MAC address values include an original source address, an immediate transmitter address, an immediate recipient address, and a final recipient address.

In an exemplary embodiment, the original source address represents the address of an originating wireless device, e.g., wireless device 100i (FIG. 1), and the final recipient address represent the address of a final wireless device, e.g., wireless device 100a (FIG. 1), intended as the final destination of the data message, e.g., an access point. In an exemplary embodiment, as will be described in detail below, the immediate transmitter and immediate recipient addresses are updated at each wireless device along a path (represented by a dashed line in FIG. 1) to move the data message from the original source wireless device to the final recipient wireless device. For example, the wireless device where the message originates, e.g., wireless device 100i, inserts its address in the original source address and the immediate transmitter address; the address of a destination wireless device, e.g., wireless device 100a, in the final recipient address; and the address of the next wireless device in the path to the final recipient, e.g., wireless device 100d, in the immediate recipient address. When received at the next wireless device in the path, e.g., wireless device 100d, that wireless device updates the immediate transmitter address to its own address and the immediate recipient address to the next wireless device in the path, e.g., wireless device 100b. This process continues until the data message reaches the final recipient. This method of forwarding the data messages is an extension of the 802.11 standard to allow forwarding of the data messages in the link layer 308.

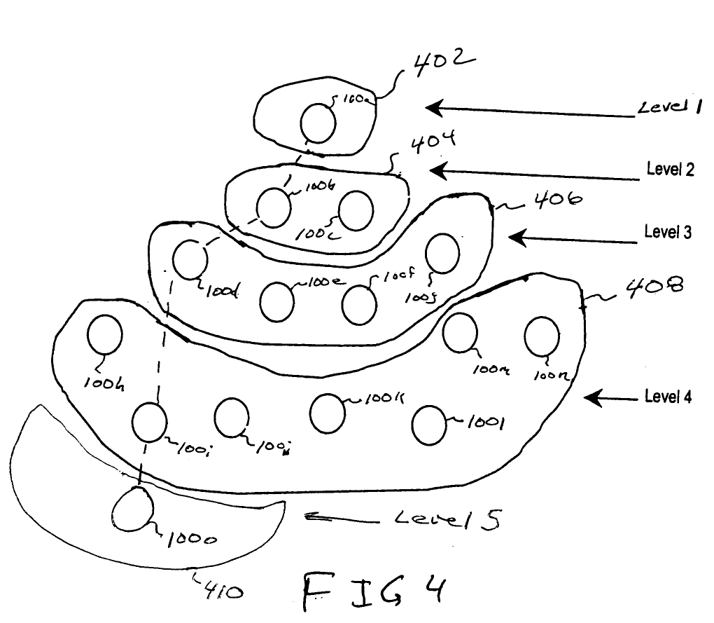

In an exemplary embodiment of the present invention, the MAC addresses are used to send data between two wireless devices in a wireless network based on a discovered hierarchy among the wireless devices. The hierarchy is implemented as levels of wireless devices in the wireless network with respect to the access point. FIG. 4 depicts the wireless devices 100 of FIG. 1 grouped into levels in accordance with the present invention to define a hierarchy amongst the wireless devices with respect to an access point. In an exemplary embodiment, the level corresponds to the “hop distance” of the wireless device from the access point, which is the number of wireless devices through which data from a wireless device is forwarded to reach the access point.

There are five levels in the illustrated embodiment. A first level 402 includes one wireless device (i.e., wireless device 100a), a second level 404 includes two wireless devices (i.e., wireless devices 100b and 100c), a third level 406 includes four wireless devices (i.e., wireless devices 100d-f), a fourth level 408 includes seven wireless devices (i.e., wireless device 100h-n), and a fifth level 410 includes one wireless device (i.e., 100o). Although five levels are shown, the wireless devices may be grouped into essentially any number of two or more levels. Specifically, the wireless devices are grouped such that one wireless device, i.e., the access point, is in one level and essentially any number of wireless devices are in each of the other levels, e.g., based on the proximity of the wireless devices to the access point and to one another.

In the illustrated embodiment, the first level 402 includes the access point (AP) wireless device for the wireless network. The second level 404 includes all the wireless devices that may communicate directly with the AP wireless device, i.e., transmissions there between are direct. The third level 406 includes all the wireless devices that may communicate directly with one of the wireless devices in the second level 404, but not directly with the AP wireless device. The fourth level 408 includes all the wireless devices that may communicate directly with one of the wireless devices in the third level, but not directly with the AP wireless device or any of the wireless devices in the second level. The fifth level 410 includes a wireless device that may communicate directly with one of the wireless device in the fourth level 408, but not directly with the AP wireless device or any of the wireless devices in the second and third levels.

In an exemplary embodiment, as described in greater detail below, indirect communications between wireless devices in non-adjacent levels, e.g., between the first level 402 and the fourth level 408, pass through the levels sequentially, e.g., from the first level 402 to the second level 404 to the third level 406 to the fourth level 408, and vice versa. For example, for a first wireless device in the fourth layer 408, e.g., wireless device 100i, to send a data message to the wireless device 100a in the first layer 402, the data message would pass through intermediate wireless devices in the third and second layers 406 and 404, e.g., wireless device 100d and wireless device 100b.

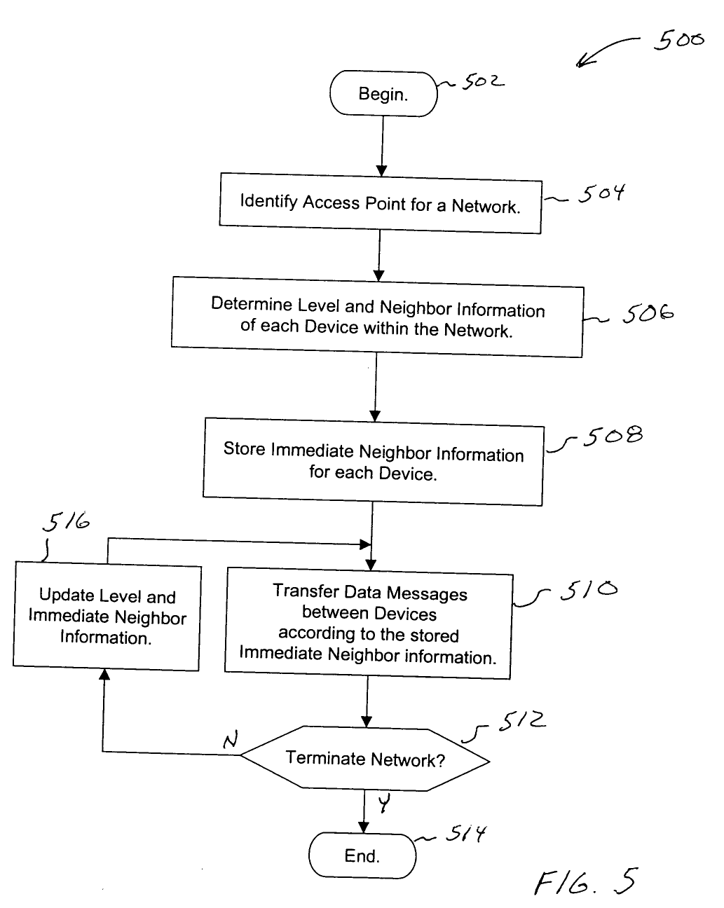

FIG. 5 depicts a flow chart 500 of exemplary steps for determining the level of each wireless device within a wireless network to establish a hierarchy for the wireless network and for determining immediate neighbor information for wireless devices with which each wireless device is configured to communicate within the established hierarchy. Processing begins at block 502 with the identification of an access point for a wireless network at block 504. In an exemplary embodiment, the access point is assigned a particular predefined level, e.g., one, and other wireless devices within the network are initially assigned a predefined non-initialized level number, e.g., zero, indicating that the level for these wireless devices is not yet determined.

At block 506, the level of each wireless device in the wireless network and immediate neighbor information for each wireless device is determined. A neighbor wireless device is any wireless device with which a wireless device is able to communicate directly and an immediate neighbor is any wireless device with which a wireless device is able to communicate that is in a level immediately above or below the level of the wireless device. In an exemplary embodiment, the wireless devices are configured to determine the level and immediate neighbor information at predefined intervals, e.g., once a second, to identify level changes. This allows the wireless network to respond efficiently to the physical movement of the wireless devices that make up the network, the addition of a new wireless device(s), and/or the removal of a wireless device(s).

In an exemplary embodiment, each wireless device periodically broadcasts its level and address. In addition, each wireless device builds a neighbor database including the levels and addresses it receives in broadcast from other wireless devices. In an exemplary embodiment, the level of a wireless device is a level that is one greater than the lowest initialized value received from any of its neighbors, e.g., the lowest non-zero value. After the level is determined, the immediate neighbors of the wireless device are easily determined by querying the entries in the neighbor database for neighboring wireless devices having a level immediately above or below the determined level of the wireless device.

An exemplary broadcast message includes a level field and a device address field. In an exemplary embodiment, the address field is the local MAC address of the wireless device. When a wireless device is first activated in a wireless network, the level field is set to zero and the wireless device broadcasts its MAC address and the non-initialized level number. Previously activated wireless devices already have their initialized levels. Accordingly, these wireless devices broadcast their address and initialized level information.

Referring to FIG. 4, by way of illustrative example, initially, wireless device 100a broadcasts a level one and all other wireless devices broadcast a zero. Ignoring the broadcasts of non-initialized wireless devices (i.e., those broadcasting zero level values), all wireless devices receiving the level one indicator, e.g., wireless devices 100b and 100c, assign a level two as their level. Subsequently, wireless device 100a broadcasts a level one and wireless devices 100b and 100c broadcast a level two. Ignoring the zero values, all wireless device receiving the level one indicator (including those also receiving the level two indicator) assign a level two as their level and all wireless devices receiving the level two indicator only, e.g., wireless devices 100d-100g, assign a level three as their level. This process continues for the duration of the wireless network.

Referring back to FIG. 5, at block 508, immediate neighbor information is stored for each wireless device. In an exemplary embodiment, one immediate neighbor in a level immediately below the level of the wireless device is used for communications to the access point. This neighbor is referred to as the parent node. In certain exemplary embodiments, known wireless devices from which the wireless device received a broadcast message in the level immediately lower than the level of the wireless device are stored in a table with the parent node indicated with a unique indicator. In certain other exemplary embodiments, only the parent node is retained in the table for this particular level. In certain other exemplary embodiments two or more of the wireless devices in the level are retained as parent nodes. Where a particular wireless device is selected, the selection, by way of non-limiting example, may be random, based of the first wireless device from which a broadcast was received, based on signal strength, or based on battery power remaining.

In an exemplary embodiment, one or more neighbor wireless devices in a level immediately above the level of the wireless device uses the wireless device for communications with the access point. These neighbors are referred to as child nodes. In certain exemplary embodiments, all known wireless devices in the level immediately above the level of the wireless device are stored in a table with the child node(s) indicated with a unique indicator. In certain other embodiment, only the child node(s) are retained in the table for this particular level. In certain other exemplary embodiments, all wireless devices in the level immediately above the level of the wireless device are stored as child node(s). Accordingly, for this embodiment, a unique indicator is unnecessary. Where a particular wireless device is selected, the selection, by way of non-limiting example, may be random, based of the first wireless device from which a broadcast was received, based on signal strength, or based on battery power remaining. In certain exemplary embodiments, the child nodes of a wireless device are those which list that particular wireless device as a parent node.

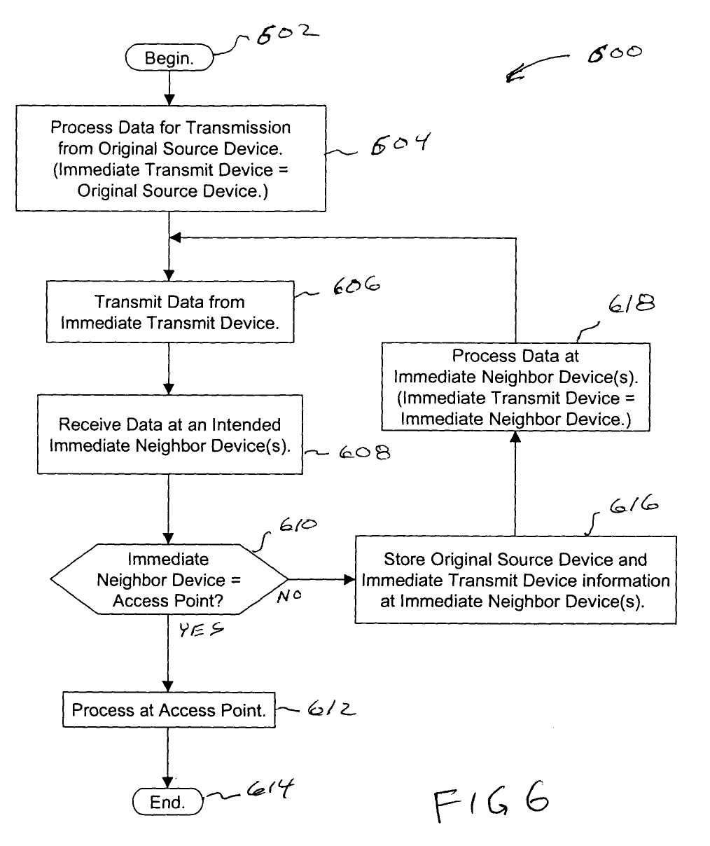

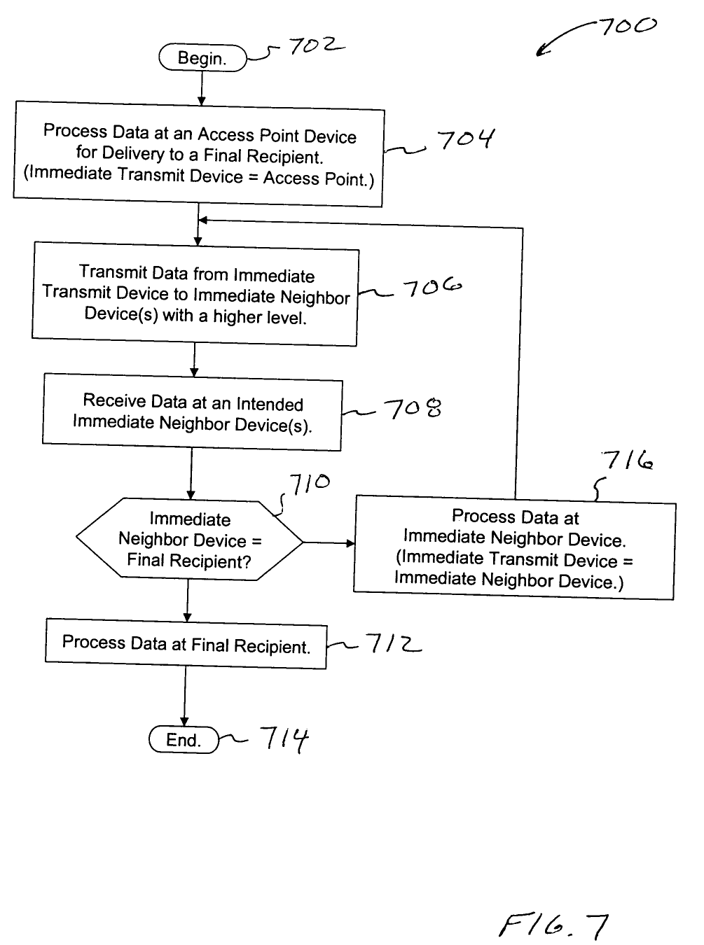

At block 510, data messages are transferred between wireless devices according to the stored neighbor information. In an exemplary embodiment, the data messages are broadcast between the wireless devices and the access point sequentially by level according to the established hierarchy in an upstream direction to the access point (described with reference to FIG. 6) and broadcast in a downstream direction from the access point (described with reference to FIG. 7).

At block 512 a decision is made regarding whether to terminate the network. If the network is terminated, processing ends at block 514. Otherwise processing proceeds at block 516. In an exemplary embodiment, processing may be terminated by removing power from the access point or if the wireless device is unable to establish contact with any wireless device.

At block 516, the level of the wireless device and the immediate neighbor information are updated to reflect the addition and deletion of wireless devices within the wireless network. In an exemplary embodiment, each immediate neighbor has a corresponding timer that is set when the immediate neighbor is stored in the table at block 508. In certain exemplary embodiments, the timers run continuously and are reset individually whenever a broadcast message from a corresponding immediate neighbor is received. The timer is monitored and, if the timer is not reset for a predefined period of time, e.g., for two broadcast message periods, the previously stored immediate neighbor is removed from the table. In certain exemplary embodiments, if all the entries for the level immediately below the wireless device are deleted, the wireless device reevaluates its level number. In certain exemplary embodiments, the wireless device monitor the broadcast messages from the neighboring wireless devices and lowers its level if a broadcast message is received from a wireless device two or more levels below the current level of the wireless device.

The stored neighbor information maintained by each of the wireless devices effectively stratifies the wireless network ensuring that a message sent from any wireless device to the AP or from the AP to any wireless device pursues a relatively direct path. The neighbor status database contains much less information than a complete forwarding table that may be maintained for use in conventional wireless forwarding systems, thus reducing processing overhead. In addition, it is implemented in a lower layer, i.e., the data link layer, rather than in the network layer as for forwarding tables in conventional ad hoc wireless networks, thus further reducing processing overhead.

FIG. 6 depicts a flow chart 600 of exemplary steps for transferring data to an access point wireless device from another wireless device in a wireless network. Processing begins at block 602 with the processing of data for transmission from a wireless device (i.e., an original source wireless device) to an access point (i.e., a final recipient wireless device) at block 604. In an exemplary embodiment, the original source wireless device creates the data message and populates the MAC addresses for the data message such that the address of the original source wireless device is entered as both the original source address and the immediate transmitter address, the address of a parent to the original source wireless device is entered as the immediate recipient address, and the address of the access point wireless device is entered as the final recipient address. In an alternative exemplary embodiment, where child information is stored with each wireless device, the original source wireless device may transmit the data message with only the addresses of the original source wireless device, the immediate transmitter wireless device, and the final destination address. In certain exemplary embodiments, it is assumed that the final destination address is the access point, thereby eliminating the need for including the final destination address. At this step, the original source wireless device is the immediate transmitting wireless device.

At block 606, the immediate source wireless device transmits the data message for receipt by at least one immediate neighbor wireless device having a lower level, i.e., a parent wireless device.

At block 608, the data message is received at one or more intended immediate neighbor wireless devices. In an exemplary embodiment, the intended immediate neighbor wireless device is the wireless device specified in the immediate recipient address field of the MAC address. In accordance with this embodiment, the immediate neighbor wireless device parses the MAC address to determine if it is the intended recipient of the data message. In an alternative embodiment, where child information is stored with each wireless device, the immediate neighbor wireless device compares the immediate transmitter address to stored child information. If there is a match, the immediate neighbor wireless device identifies itself as the intended recipient of the data message.

At block 610, a decision is made regarding the neighbor wireless device. If the neighbor wireless device is the access point, processing proceeds at block 612. Otherwise, processing proceeds at block 616.

At block 612, the access point processes the data message to derive the original message with processing ending at block 614. In an exemplary embodiment, the access point processes the data message using techniques that will be readily apparent to those of skill in the art of wireless network signal processing.

At block 616, which is reached if at block 610 it is determined that the immediate neighbor wireless device is not the access point, the address of the original source wireless device is stored at the immediate neighbor wireless device having the lower level. In an exemplary embodiment, the original source address is stored in a memory at the neighbor wireless device in a down stream processing table, described below with reference to FIG. 7, for use in forwarding data messages down stream from the access point to another wireless device within the wireless network. In an alternative exemplary embodiment, the address of the immediate transmitter wireless device is also stored in connection with the original source wireless device address. In an exemplary embodiment, the down stream processing table is periodically updated to remove the addresses of wireless devices from which a broadcast message has not been received for a predefined period of time. For example, if each wireless device is configured to transmit a broadcast message every 15 milliseconds, the address of a wireless device is removed if a broadcast message is not received for two broadcast message periods, e.g., 30 milliseconds.

At block 618, the data message is processed at the intended immediate neighbor device(s). In an exemplary embodiment, the immediate neighbor wireless device inserts its address as the immediate transmitter address and the address of a parent as the immediate recipient address. In an alternative exemplary embodiment, where child information is stored with each wireless device, the immediate neighbor wireless device may transmit the data message with only the addresses of the original source wireless device, the immediate transmitter wireless device, and, optionally, the final destination. At this step, the immediate neighbor device is the immediate transmit device. Processing then continues to cycle through blocks 606, 608, 610, 616, and 618 until the access point wireless device is reached.

FIG. 7 depicts a flow chart 700 of exemplary steps for transferring a data message from an access point wireless device to another wireless device in a wireless network. Processing begins at block 702 with processing of the data message at the access point wireless device for delivery to the final recipient wireless device at block 704. In an exemplary embodiment, the access point wireless device populates the MAC addresses for the data message such that the address of the access point wireless device is entered as both the original source address and the immediate transmitter address, and the address of the destination wireless device is entered as the final recipient. In an exemplary embodiment, the immediate recipient address is ignored during the transfer of data from the access point to the another wireless device and, therefore, may contain essentially any value. In an alternative exemplary embodiment, the address of a child to the access point wireless device is entered as the immediate recipient address. At this step, the access point wireless device is the immediate transmit device.

At block 706, the immediate transmit device transmits the data message to an immediate neighbor device(s) with a higher level adjacent the level of the immediate transmit device, i.e., a child wireless device.

At block 708, the data message is received at one or more intended immediate neighbor wireless devices. In an exemplary embodiment, the immediate neighbor wireless device parses the MAC address of received data messages to identify the final recipient address. If the immediate neighbor wireless device has knowledge of the final recipient, e.g., in a down stream processing table associated with the immediate neighbor wireless device, the immediate neighbor wireless device identifies itself as the intended recipient of the data message. In an alternative exemplary embodiment, the intended immediate neighbor wireless device is a wireless device specified in the immediate recipient address field of the MAC address.

At block 710, a decision is made regarding the immediate neighbor wireless device. If the immediate neighbor wireless device is the final recipient, processing proceeds at block 712. Otherwise, processing proceeds at block 716.

At block 712, the final recipient wireless device processes the data message to derive the original message with processing ending at block 714. In an exemplary embodiment, the final recipient wireless device processes the data message using techniques that will be readily apparent to those of skill in the art of wireless network signal processing.

At block 716, which is reached if, at block 710, it is determined that the immediate neighbor wireless device is not the final recipient wireless device, the data is processed at the immediate neighbor wireless device. In an exemplary embodiment, the immediate neighbor wireless device updates the MAC address to list its address as the immediate transmitter address. In an alternative exemplary embodiment, the immediate neighbor wireless device further updates the MAC address to the list address of a child as the immediate receiver address. If there are multiple children, separate data messages for each child with the address of that child in the immediate recipient address field may be sent. Processing then proceeds through blocks 706, 708, 710, and 716 until the data message reaches the final recipient wireless device.

Referring once again to FIG. 4, in an exemplary upstream example, wireless device 100i in level 4 transmits a message that it wants to go to the access point wireless device, e.g., wireless device 100a in level 1. Assuming wireless device 100i has wireless device 100d as its parent, wireless device 100i sends a message, which is received and processed by wireless device 100d. In an exemplary embodiment, wireless device 100d stores an indicator corresponding to wireless device 100i in a down stream processing table for wireless device 100d. Thus, wireless device 100d now has knowledge of wireless device 100i. Assuming wireless device 100d has wireless device 100b as a parent, wireless device 100d, in turn, broadcasts the message, which is received and processed by wireless device 100b. In an exemplary embodiment, wireless device 100b stores an indicator corresponding to wireless devices 100i and 100d in a down stream processing table for wireless device 100b. Thus, wireless device 100b now has knowledge of wireless devices 100i and 100d. Further, assuming wireless device 100b has wireless device 100a as a parent, wireless device 100b, in turn, broadcasts the message to the wireless device 100a, i.e., the access point wireless device. If each wireless device has a single parent node, there is only a single path through the wireless network for any message in the upstream direction toward the access point. In certain exemplary embodiments, the wireless devices only acquire knowledge of the original source address and the immediate transmitter address. For example, if the original source address is for wireless device 100o and the data is forwarded through wireless devices 100i, 100d, and 100b to reach the access point 100a, wireless device 100b would only acquire knowledge of wireless devices 100o and 100d, rather than wireless devices 100o, 100i, and 100d.

In an exemplary down stream example, wireless device 100a in level 1, i.e., the access point wireless device, transmits a message that it wants to go to another wireless device in the wireless network, e.g., wireless device 100i in level 4, from which a message was previously received. Wireless device 100a sends a message, which is received and processed by wireless devices 100b and 100c. Assuming wireless device 100b has knowledge of wireless device 100i, e.g., from its down stream processing table, and wireless device 100c has no knowledge of wireless device 100i, wireless device 100b only will process the message from wireless device 100a. Wireless device 100b then sends a message, which is received and processed by wireless devices 100d, 100e, and 100f. (It is assumed that although wireless device 100g is in the same level as wireless device 100d, e, and f, it is out of transmitting range of wireless device 100b and, therefore, does not receive the message.) Assuming only wireless device 100d has knowledge of wireless device 100i, e.g., from its down stream processing table, wireless device 100d only will process the message from wireless device 100b. Wireless device 100d then sends a message, which is received and processed by wireless device 100i.

In certain exemplary embodiments, the wireless devices are capable of being configured for use with multiple wireless networks associated with respective multiple access points. In accordance with these embodiments, an access point ID may be included in the broadcast messages and stored in tables within the wireless devices along with level information. Accordingly, when a wireless device desires the use of one of the multiple access points, the wireless device uses parent and child nodes associated with a particular access point and ignores the parent and child nodes associated with the other access point(s). In certain other exemplary embodiments, the wireless device may be configured for use with more than one access point concurrently. For example, the wireless device may use one access point to access the Internet and another access point to access a printing device.

In certain multiple access point systems, the wireless device selects which wireless network associated with the access points to use based on predetermined criteria. The predetermined criteria may be, by way of non-limiting example, the wireless network with the minimum number of “hops” to an access point or the wireless network with the lowest load levels. For example, if the predetermined criteria is the lowest load levels and the wireless device is being used in a convention center with multiple access points, the wireless device may select a little used wireless network access point in a sparsely populated area of the convention center rather than a heavily used wireless network access point in a popular area of the convention center even if many more hops are necessary. Thus, the present invention may be used to achieve load balancing among multiple wireless networks.

Although the components of the present invention have been described in terms of specific components, it is contemplated that one or more of the components may be implemented in software running on a general purpose computer. In this embodiment, one or more of the functions of the various components may be implemented in software that controls the general purpose computer. This software may be embodied in a computer readable carrier, for example, a magnetic or optical disk, a memory-card or an audio frequency, radio-frequency or optical carrier wave.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A data communication method for use in a wireless network having an access point, the method comprising the steps of:
determining a level for each of a plurality of wireless devices of the wireless network with respect to the access point;
determining for each of the plurality of wireless devices neighboring ones of the plurality of wireless devices having adjacent levels; and
transferring data messages between one of the plurality of wireless devices and the access point sequentially by level through at least one other one of the plurality of wireless devices.

2. The method of claim 1, wherein the level determining step comprises at least the steps of:
at each wireless device in the wireless network,
sending a broadcast message;
receiving broadcast messages from neighboring ones of the plurality of wireless devices, the broadcast messages indicating a neighbor level for each of the neighboring wireless devices; and
determining the level for the wireless device responsive to the neighbor levels.

3. The method of claim 2, wherein the step of determining the level for the wireless device responsive to the neighbor levels comprises:
building a neighbor status database including the neighboring levels from the received broadcast messages;
identifying the neighboring level having a lowest initialized value; and
assigning a level one greater than the neighboring level having the lowest initialized value.

4. The method of claim 3, further comprising the step of:
maintaining the neighboring status database in a data link layer.

5. The method of claim 1, further comprising the step of:
updating the level for each of the plurality wireless devices at a predefined interval.

6. The method of claim 1, wherein the transferring data messages step comprises at least the step of:
forwarding messages through the at least one other one of the plurality of wireless devices in a data link layer.

7. The method of claim 1, wherein the data message includes a original source address, an immediate transmitter address, and an immediate recipient address, and wherein the transferring data messages step for communication from the one of the plurality of wireless devices to the access point comprises at least the steps of:
(a) processing the data message for transmission from the one of the plurality of wireless devices to the access point, the one of the plurality of wireless devices populating the original source address and the immediate transmitter address with a source address corresponding to the one of the plurality of wireless device and the immediate recipient address with an upstream neighbor address corresponding to an immediate upstream neighboring wireless device;
(b) transmitting the data message to the immediate recipient address;
(c) receiving the data message at the immediate upstream neighboring wireless device corresponding to the immediate recipient address;
(d) storing the original source address and the immediate transmitter address of the data message in a down stream processing table associated with the immediate upstream neighboring wireless device; and
(e) processing the data message for transmission to an other immediate upstream neighboring wireless device having a lower adjacent level than the immediate upstream neighboring wireless device, wherein the immediate transmitter address is updated to match the address of the immediate upstream neighboring wireless device and the immediate recipient address is updated to match the address of the other immediate upstream neighboring wireless device.

8. The method of claim 7, further comprising the steps of:
repeating step (b) through step (e) until the data message reaches the access point.

9. The method of claim 7, wherein the transferring data messages step for communications from the access point to the one of the plurality of wireless devices comprises at least the steps of:
(f) processing the data message for transmission from the access point to one of the plurality of wireless devices, the access point populating the final recipient address with a final destination address corresponding to the one of the plurality of wireless devices, wherein initially, the access point is an immediate downstream transmitter wireless device;
(g) transmitting the data message from the immediate downstream transmitter wireless device;
(h) receiving the data message at immediate down stream neighboring wireless device(s), each immediate down stream neighboring wireless device having an associated down stream process table; and
(i) processing the data message for transmission from the immediate down stream neighboring wireless device(s) if the final recipient address is located in the down stream processing table associated with the immediate down stream neighboring wireless device(s), wherein the immediate down stream neighboring wireless device(s) becomes the immediate down stream transmitting device.

10. The method of claim 9, wherein the transferring data messages step for communications from the access point to the one of the plurality of wireless devices further comprises at least the step of:
repeating step (f) through step (i) until the immediate down stream neighboring wireless device is the one of the plurality of wireless devices.

11. A method for use in a wireless network including a plurality of wireless devices to determine a level for each wireless device with respect to an access point, the method comprising the steps of:
at each wireless device in the wireless network,
sending a broadcast message;
receiving broadcast messages from neighboring ones of the plurality of wireless devices, the broadcast messages indicating a neighbor level for each of the neighboring wireless devices; and
determining the level for the wireless devices responsive to the neighbor levels.

12. The method of claim 11, wherein the step of determining the level for the wireless devices responsive to the neighbor levels comprises:
building a neighbor status database including the neighboring levels from the received responses;
identifying the neighboring level having a lowest initialized value; and
assigning a level one greater than the neighboring level having the lowest initialized value.

13. The method of claim 12, further comprising the step of:
maintaining the neighboring status database as a data link layer database.

14. A wireless device for use in a wireless network including a plurality of wireless devices and an access point, the wireless devices capable of determining a level with respect to the access point, the wireless device comprising:
a transceiver that sends a broadcast message and receives broadcast messages from neighboring ones of the plurality of wireless devices, the broadcast messages indicating a neighbor level for each of the neighboring wireless devices; and
a controller coupled to the transceiver that generates the broadcast message and determines the level of the wireless device responsive to the neighbor levels.

15. The wireless device of claim 14, wherein the controller determines the level of the wireless device by building a neighbor status database including the neighboring levels from the received broadcast messages, identifying the neighboring level having a lowest initialized value, and assigning a level one greater than the neighboring level having the lowest initialized value.

16. The wireless device of claim 14, further comprising:
a memory coupled to the controller that stores information relating to neighboring ones of the plurality of wireless devices in levels adjacent the determined level of the wireless device.

17. A data communication system for use in a wireless network having an access point, the system comprising:
means for determining a level for each of a plurality of wireless devices of the wireless network with respect to the access point;
means for determining, for each of the plurality of wireless devices, neighboring ones of the plurality of wireless devices having adjacent levels; and
means for transferring data messages between one of the plurality of wireless devices and the access point sequentially by level through at least one other one of the plurality of wireless devices.

18. The system of claim 17, wherein the means for transferring data messages comprises:
means for forwarding messages through the least one other of the plurality of wireless devices in a data link layer.

19. A computer readable carrier including software that is configured to control a general purpose computer to implement a method for use by a wireless device within a wireless network having an access point and a plurality of wireless devices to determine a level for the wireless device with respect to the access point, the method comprising the steps of:
sending a broadcast message;
receiving broadcast messages from neighboring ones of the plurality of wireless devices, the broadcast messages indicating a neighbor level for each of the neighboring wireless devices; and
determining the level for the wireless device responsive to the neighbor levels.

20. The computer readable carrier of claim 19, wherein the software that is configured to control the general purpose computer to determine the level for the wireless device comprises software for:
building a neighbor status database including the neighboring levels from the received broadcast messages;
identifying the neighboring level having a lowest initialized value; and
assigning a level one greater than the neighboring level having the lowest initialized value.
